(19) United States
(12) Patent Application Publication
(10) Pub. No.: US 2024/0335001 A1
(43) Pub. Date: Oct. 10, 2024

(54) ADDITIVE MANUFACTURED ICE SKATE BOOT

(71) Applicant: Edward Lafe Altshuler, Dacono, CO (US)

(72) Inventor: Edward Lafe Altshuler, Dacono, CO (US)

(21) Appl. No.: 18/131,421

(22) Filed: Apr. 6, 2023

(51) Int. Cl. A43B 5/16; A43B 13/12; A43B 13/14; A43B 23/02; A43D 11/00; B33Y 10/00; B33Y 80/00

(52) U.S. Cl. CPC A43B 5/1641; A43B 13/12; A43B 13/14; A43B 23/0235; A43D 11/003; B33Y 10/00; B33Y 80/00; A43D 2200/60

(57) ABSTRACT

An additive manufactured hard-shell athletic boot with an integrated sole and foot form that includes a sole form and foot form is contemplated. The athletic boot can comprise a composite overlay, such as a carbon composite, that covers the majority of an outer surface of the sole form and the majority of an outer surface of the foot form. In certain instances, the overlay covers the integrated sole and foot form up to an overlay border that runs along the top of the integrated sole and foot form. One example of a hard-shell athletic boot is a hockey skate boot.

### CROSS-REFERENCE TO RELATED APPLICATION

None.

### FIELD OF THE INVENTION

The present invention relates generally to the field of sports footwear, and more particularly to manufacturing and construction of performance footwear.

### DESCRIPTION OF RELATED ART

The present embodiments are generally directed to sports footwear, and more particularly to manufacturing and construction of performance footwear, such as ice skate boots.

The right performance footwear, especially as it applies to sports such as hockey, can give an athlete a competitive edge. In that regard, there are a number of factors considered in the production of performance footwear including weight, foot support, performance durability and of course manufacturing. It is to innovations related to improving hard-shell sports footwear that the subject matter disclosed herein is generally directed.

### SUMMARY OF THE INVENTION

The present embodiments are generally directed to hard shell sports footwear, and more particularly to manufacturing and construction of performance footwear, such as ice skate boots.

In that light, certain embodiments of the present invention contemplate an athletic boot comprising an additive manufactured integrated sole and foot form that includes a sole form and foot form. The athletic boot further comprises a composite overlay that essentially covers a majority of an outer surface of the sole form and a majority of an outer surface of the foot form. A majority meaning around 75%-80%. Certain embodiments envision the overlay covering the integrated sole and foot form up to an overlay border that runs along the top of the integrated sole and foot form. If the athletic boot is an ice skate boot, the overlay leaves open the mounting holes in the overlay sole portion of the ice skate. Some embodiments envision at least one type of compressible insulation layer fitted against essentially all of an inner surface of the sole and the foot form, the athletic boot is configured to be worn on a human foot. The compressible insulation is intended to add comfort from an otherwise stiff additive manufactured integrated sole and foot form.

Yet another embodiment contemplates athletic footwear comprising an additive manufactured integrated sole and foot form that includes a sole form and foot form in addition to a composite overlay that essentially covers between 50%-90% of an outer surface of the sole form and between 50%-90% of an outer surface of the foot form. The athletic footwear is configured to be worn on a human foot.

An embodiment for a method of manufacturing an athletic boot can comprise 3-D printing an additive manufactured integrated sole and foot form that includes a sole form and foot form. Next, apply a composite overlay to the additive manufactured integrated sole and foot form in a manner that essentially covers at least 50% of an outer surface of the sole form and at least 50% of an outer surface of the foot form. In certain embodiments, at least one type of compressible insulation layer can be fitted against essentially all of an inner surface of the sole and the foot form. The athletic boot is configured to be worn on a person's foot.

### BRIEF DESCRIPTION OF THE DRAWINGS

FIG. 1A is a line drawing that illustratively depicts a top exploded view of an ice skate boot and overlay arrangement consistent with embodiments of the present invention;

FIG. 1B is a line drawing that illustratively depicts a bottom exploded view of the ice skate boot and overlay arrangement of FIG. 1A consistent with embodiments of the present invention;

FIG. 2 is a line drawing depicting the side view of the skate boot and overlay arrangement consistent with embodiments of the present invention;

FIGS. 3A and 3B is a side view and top view of cross-section line drawing of a sole and foot form embodiment consistent with embodiments of the present invention;

FIG. 4 is an isometric view of the ice skate boot and overlay arrangement with the overlay attached to the sole and foot form consistent with embodiments of the present invention;

FIGS. 5A and 5B are line drawings of an ice skate assembly that includes the ice skate boot and overlay arrangement consistent with embodiments of the present invention; and

FIG. 6 illustratively depicts a sole insert that is envisioned to be disposed inside of the sole and foot form consistent with embodiments of the present invention.

### DETAILED DESCRIPTION

Initially, this disclosure is by way of example only, not by limitation. Thus, although the instrumentalities described herein are for the convenience of explanation, shown and described with respect to exemplary embodiments, it will be appreciated that the principles herein may be applied equally in other similar configurations involving the subject matter directed to the field of the invention. The phrases “in one embodiment”, “according to one embodiment”, and the like, generally mean the particular feature, structure, or characteristic following the phrase, is included in at least one embodiment of the present invention and may be included in more than one embodiment of the present invention. Importantly, such phases do not necessarily refer to the same embodiment. If the specification states a component or feature “may”, “can”, “could”, or “might” be included or have a characteristic, that particular component or feature is not required to be included or have the characteristic. As used herein, the terms “having”, “have”, “including” and “include” are considered open language and are synonymous with the term “comprising”. Furthermore, as used herein, the term “essentially” is meant to stress that a characteristic of something is to be interpreted within acceptable tolerance margins known to those skilled in the art in keeping with typical normal world tolerance, which is analogous with “more or less.” For example, essentially flat, essentially straight, essentially on time, etc. all indicate that these characteristics are not capable of being perfect within the sense of their limits. Accordingly, if there is no specific +/− value assigned to “essentially”, then assume essentially means to be within +/−2.5% of exact. The term “connected to” as used herein is to be interpreted as a first element physically linked or attached to a second element and not as a “means for attaching” as in a “means plus function”. In fact, unless a term expressly uses “means for” followed by the gerund form of a verb, that term shall not be interpreted under 35 U.S.C. § 112 (f). In what follows, similar or identical structures may be identified using identical callouts.

With respect to the drawings, it is noted that the figures are not necessarily drawn to scale and are diagrammatic in nature to illustrate features of interest. Descriptive terminology such as, for example, upper/lower, top/bottom, horizontal/vertical, left/right and the like, may be adopted with respect to the various views or conventions provided in the figures as generally understood by an onlooker for purposes of enhancing the reader's understanding and is in no way intended to be limiting. All embodiments described herein are submitted to be operational irrespective of any overall physical orientation unless specifically described otherwise, such as elements that rely on gravity to operate, for example.

The present embodiments are directed to an athletic boot comprising an additive manufactured integrated sole and foot form that includes a sole form and foot form. The additive manufactured boot is referred to herein as a form because it is 3-D printed. More specifically, 3-D printed elements are synonymous with additive manufactured elements. The athletic boot further comprises a composite overlay that essentially covers between 50-90% of an outer surface of the sole form and between 50-90% of an outer surface of the foot form. Certain embodiments envision the overlay covering the integrated sole and foot form up to an overlay border that runs along the top of the integrated sole and foot form. In an embodiment where the athletic boot is an ice skate boot; the overlay leaves open the mounting holes in the overlay sole portion of the ice skate. Some embodiments envision at least one type of compressible insulation layer fitted against essentially all an inner surface of the sole and the foot form, the athletic boot is configured to be worn on a human foot. The compressible insulation is intended to add comfort from an otherwise stiff additive manufactured integrated sole and foot form.

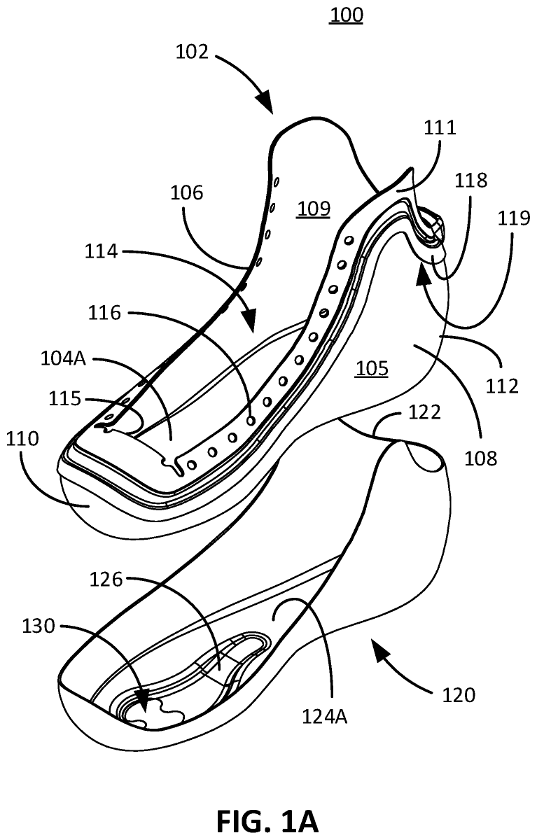

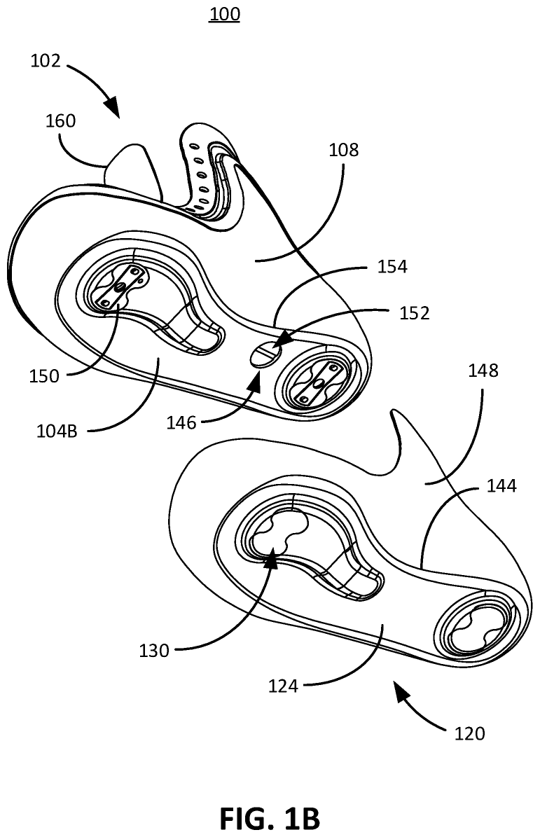

FIG. 1A is a line drawing that illustratively depicts a top view of a hard-shell ice skate boot and overlay arrangement in an exploded view consistent with embodiments of the present invention. The ice skate boot and overlay arrangement 100 generally comprises an additive manufactured integrated sole and foot form 102, or simply “sole and foot form”, that is substantially covered with a composite overlay 120, or simply “overlay”. The sole and foot form 102 is a three dimensionally (3-D) printed boot with the overlay 120 covering the main body of the sole and foot form 102. The hard-shell overlay 120 is for strength and rigidity in what might otherwise be a non-durable sole and foot form 102 that could independently handle the stress imposed on a boot.

The two main portions of the sole and foot form 102 are a form sole portion 104 and a form foot portion 106. The inside of the form sole portion 104A is shown here and the outside of the form sole portion 104B is facing downward (when generically referring to the form sole portion 104, the callout is simply 104). The form foot portion 106 is defined by a pair of opposing foot sides 108 (left and right), a toe box 110 and a heel portion 112. In the present embodiment, the form foot portion 106 does not include a tongue 160, which is shown in FIG. 1B, that would cover the bridge space 114 between the boot cuffs 111 at the shoelace eyelets 116. One arrangement envisions a tongue attached to a foot box tongue edge 115 at the edge of the toe box 110. The tongue would be configured to cover the bridge of a person's foot. In this configuration, the form foot portion 106 includes an overlay border 118 that forms a lip that defines an overlay border gap 119. The overlay border gap 119 accommodates the overlay top edge 122 of the overlay 120 (i.e., the overlay top edge 122 tucks into the overlay border gap 119. The form sole portion 104 is defined below the form foot portion 106 and is where the pad of a wearer's foot interfaces when wearing the boot arrangement 100. As defined herein, additive manufactured elements (such as the additive manufactured integrated sole and foot form 102) are 3-D printed elements that can be formed by laser sintering various powders, such as nylon, polycarbonate (PC), acrylonitrile butadiene styrene (ABS), poly ether ester ketone (PEEK), polyetherimide (ULTEM), etc., or some combination, for example. The sole and foot form 102 are integrated in this embodiment meaning that they are one contiguous element and not two or more separate elements patched together. Other embodiments envision multiple elements comprising the sole and foot form and are later integrated (e.g., snapped together).

The overlay 120 is a shell that encapsulates and conforms to most of the sole and foot form 102 up to the overlay border 118. In certain embodiments, the overlay top edge 122 butts up against the overlay border 118. Other embodiments envision the overlay top edge 122 tucked at least partially inside of the overlay border gap 119 such that the overlay top edge 122 is not exposed. Certain embodiments envision the overlay 120 being a composite carbon fiber shell, fiberglass shell, Kevlar, some combination, etc. The overlay top edge 122 may be rough, sharp or otherwise tactilely unpleasant to a person touching it, hence having the overlay top edge 122 tucked inside of the overlay border gap 119 prevents a person from being able to touch the overlay top edge 122, thus avoiding any suboptimal tactile experience (like fingers getting pricked or cut). As depicted here, the overlay 120 encapsulates the outside 105 of the sole and foot form 102. Certain embodiments envision the overlay 120 being a composite carbon fiber shell that is manually wrapped over the outer form 105 of the sole and foot form 102. The inner surface of the overlay sole portion 124 mates with or otherwise conforms to the outer portion of the form sole portion 104B. Also shown are the front mounting platform 126 and mounting hole/aperture 130.

FIG. 1B is a line drawing that illustratively depicts a bottom view of the ice skate boot and overlay arrangement exploded consistent with embodiments of the present invention. With reference to the sole and foot form 102, the sole form portion 104 is prominently shown delineated from the form side 108 by way of a form sole boarder 154. Certain embodiments do not comprise a clear delineation between the sole form portion 104 and the form side 108. In this case, there may be a round of between 0.25 to 0.5 inches (or a little more or less, e.g., 0.185-1 inch) connecting the sole form portion 104 and the form side 108. The round or blending region between the sole form portion 104 and the form side 108 is considered essentially where the sole form portion 104 meets the form side 108. Likewise, the overlay sole boarder 144 may not be a clear delineation between the overlay sole portion 124 and the overlay foot side 148. In such cases, the blending region between the overlay sole portion 124 the overlay foot side 148 is considered where the overlay sole portion 124 essentially meets the overlay foot side 148. Also shown here is a top portion of the tongue 160, a pair of ice skate mounting plates 150, one being attached to the form's front mounting platform 126 and the other being attached to the form's rear mounting platform 128. The overlay mounting holes 130 provides access to the ice skate mounting plates 150. This embodiment, the sole form portion 104 comprises a sole form void 152 interposed between the inner sole form portion 104A and the outer sole form portion 104B. This void/spacing 152 can be filled with foam to add a barrier between the inner sole form portion 104A and the outer sole form portion 104B to function as a shock absorber and/or otherwise provide added comfort to the wearer. In this embodiment, the sole form void 102 is accessed by way of a sole void port 146 in the sole form portion 104, which could be located on either the inner sole form portion 104A and/or the outer sole form portion 104B. Optionally, the sole form void 102 can be a honey comb or some other network of internal structures to add rigidity and support the weight of a wearer when using the ice skate boot and overlay arrangement 100. It is envisioned that the inner surface 109 of the additive formed integrated sole and foot form 102 is covered or otherwise fitted with a compressible insulation layer (not shown) to provide comfort to the wearer.

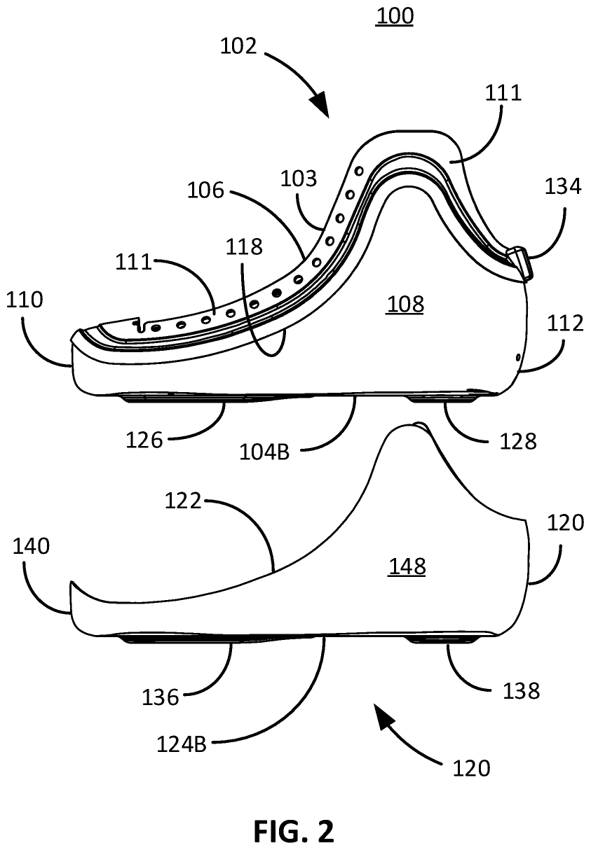

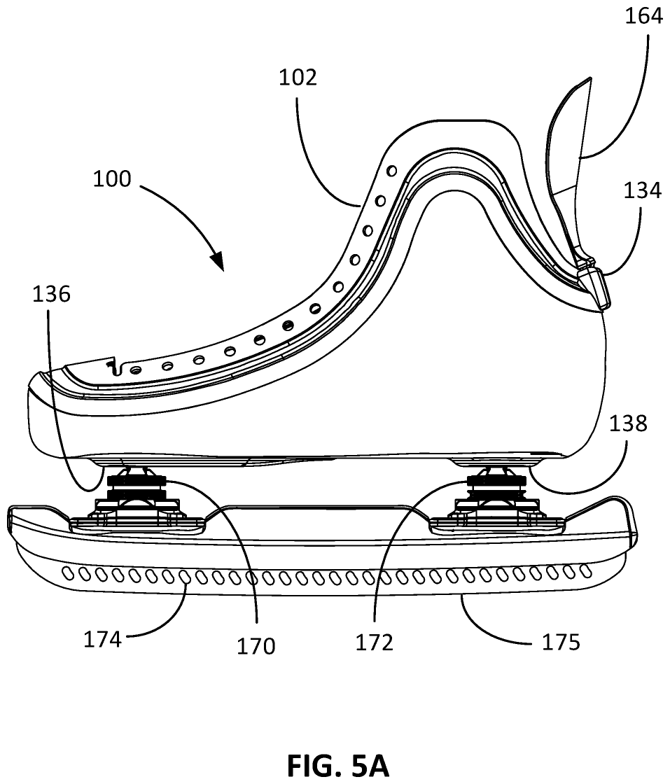

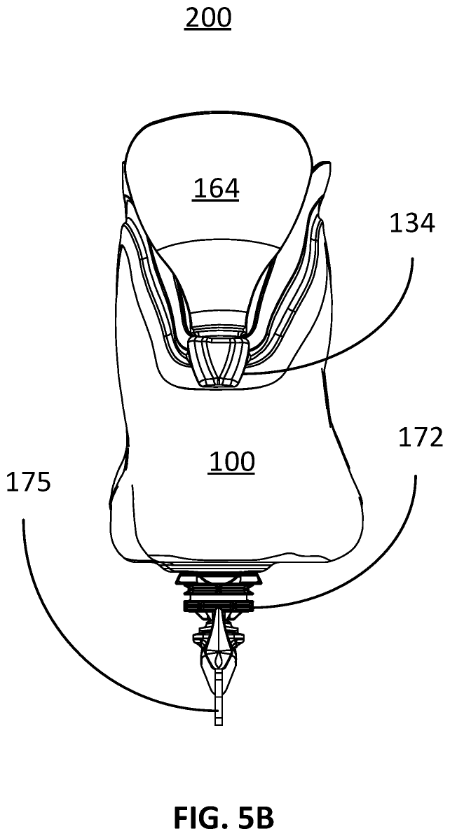

FIG. 2 is a line drawing depicting the side view of the skate boot and overlay arrangement 100 consistent with embodiments of the present invention. With reference to the sole and foot form 102, the main part of the form foot portion 106 is defined by a pair of foot sides 108, a toe box 110 and a heel portion 112. Of course, other features can make up the form portion 106, such as the eyelets 116 or the overlay border 118 and the boot cuff 111, for example. The boot cuff 111 is a lip that extends to a foot form open border 103. The foot form open border 103 is where the boot wearer would slide their foot into the sole and foot form 102. The overlay border 118 essentially conforms to the shape of the overlay top edge 122. As previously mentioned, the overlay 120 provides added rigidity and toughness to protect the wearer's foot upon receiving an impact, such as from a hockey puck, for example. At least the front of the toe box 110 is covered by the overlay 120 along the outside of the form sole portion 104B (except for the mounting holes 130), the outside of the toe box 110 and foot sides 108. In this arrangement, and integrated tendon guard attachment 134 is located at or above the overlay border 118 in the heel portion 112 of the foot form portion 106. The integrated tendon guard attachment 134 is configured and arranged to receive a tendon guard 164 of FIG. 5A.

With reference to the overlay 120, certain embodiments envision a fiber mesh soaked in a liquid resin being wrapped over the sole and foot form outside surface 105 up to the overlay boarder 118 and then cured and hardened into a composite wrap. Accordingly, the shape of the overlay 120 matches the shape of the sole and foot form 102. Hence, as shown at the outer overlay sole portion 124B, the overlay front mounting platform 136 conforms to the form's front mounting platform 126 and the overlay rear mounting platform 138 conforms to the form's rear mounting platform 128. As mentioned earlier, the overlay top edge 122 can be tucked into the overlay border gap 119. For reference, the overlay heel portion 132 conforms to the form heel portion 112, the overlay toe region 140 conforms to a portion of the form toe box 110, and the overlay foot sides 148 conform to the form foot sides 108.

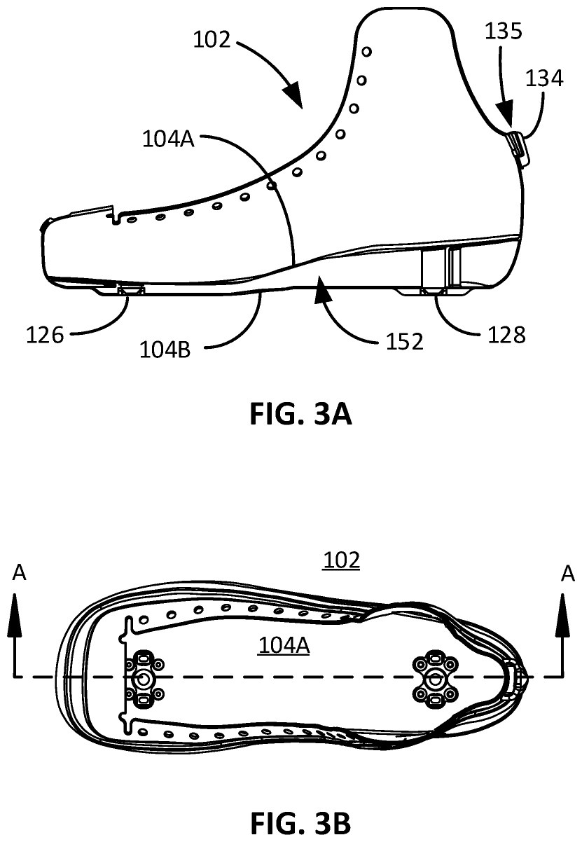

FIG. 3A is a side view cross-section line drawing of a sole and foot form embodiment 102 of FIG. 3B consistent with embodiments of the present invention. FIG. 3B is a top view of the sole and foot form 102 looking into the boot to reveal the inner sole form portion 104A with a cross-section cutline A-A extending along the center of the sole and foot form 102, as shown. FIG. 3A depicts the sole and foot form 102 along cross-section A-A showing the sole form void 152 located between the upper sole form portion 104A and the lower sole form portion 104B. The sole form void 152 is configured to receive an expandable foam that, in certain embodiments, can solidify to form a rigid or semirigid lightweight rigid volume of material between the upper sole form portion 104A and the lower sole form portion 104B. In some cases, dampening vibration foam or other material can fill or partially fill the void 152. In some embodiments, there is no void that is integrated between the upper sole form portion 104A and the lower sole form portion 104B, instead, a separate non-integrated riser/insert can be inserted through the bridge space 114 of FIG. 1A. From this cross-section view, a tendon guard receiving slot 135 is shown inside of the integrated tendon guard attachment 134. In this arrangement, the tendon guard attachment 134 comprises a snap feature that retains a tendon guard 164 of FIG. 5A. For reference, the form's mounting platforms 126 and 128 are shown.

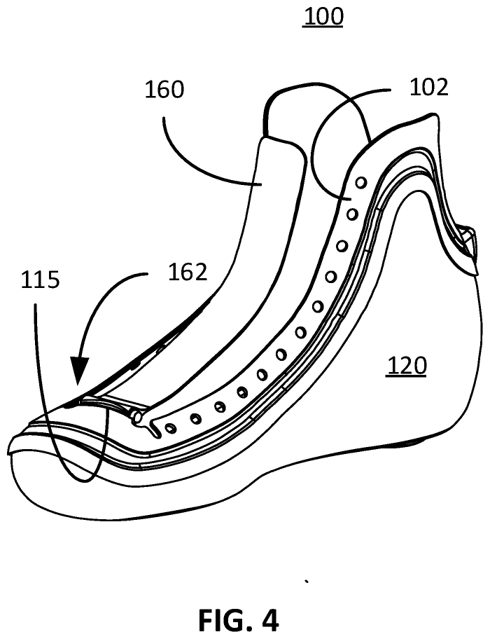

FIG. 4 is an isometric view of the ice skate boot and overlay arrangement 100 with the overlay 120 attached to the sole and foot form 102 consistent with embodiments of the present invention. In certain embodiments the overlay 120 is bonded or otherwise fixedly attached to the sole and foot form 102. In one embodiment, the overlay 120 bonds to the sole and foot form 102 via a resin that is used with a mesh (such as carbon or Kevlar mesh, for example) that is pressed against the sole and foot form 102 to create the composite overlay 120. In this arrangement, a tongue 160 is attached to the foot box tongue edge 115 via a hinge assembly 162.

FIGS. 5A and 5B are line drawings of an ice skate assembly 200 that includes the ice skate boot and overlay arrangement consistent with embodiments of the present invention. FIG. 5A is a side view of the ice skate assembly with an ice skate blade 175 attached to the mounting platforms 136 and 138 via a front skate-to-boot post 170 and a back skate-to-boot post 172. This embodiment includes a tendon guard 164 attached to the tendon guard attachment 134. The ice skate boot assembly 200 utilizes the ice skate boot and overlay arrangement 100 that includes the sole and foot form 102 integrated with the overlay 120. The ice skate blade 175 in this embodiment includes a plurality of blade perforations 174 to reduce weight and control stiffness along the blade 175 depending on the dispersion of the perforations 174.

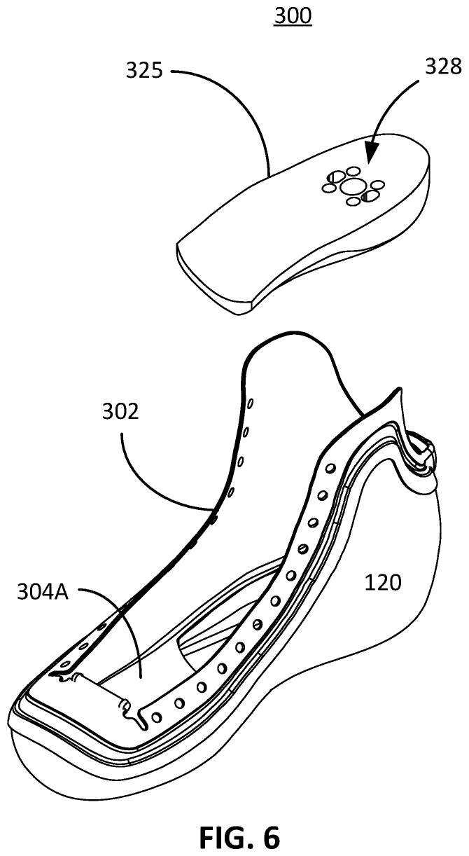

FIG. 6 illustratively depicts a sole insert 325 that is envisioned to be disposed inside of the sole and foot form 302 in place of a void. In other words, in this embodiment the sole and foot form 302 has no void or space separated between an inner sole form surface 104A and an outer sole form surface 104B, rather an insert 325 is inserted in the sole and foot form 302 on or at the sole form portion 304A. The insert can be a gel, foam, rigid platform, or some combination. The insert 325 comprises rear mounting platform receiving holes 328. In accordance with some of the other embodiments of the present invention, the ice skate boot and overlay arrangement 300 comprises an overlay 120 that overlays the sole and foot form 302.

With the present description in mind, below are some examples of certain embodiments illustratively complementing some of the methods and apparatus embodiments to aid the reader. The elements called out below are examples provided to assist in the understanding of the present invention and should not be considered limiting.

In that light, certain embodiments of the present invention contemplate an athletic boot 100 as shown in FIG. 1A comprising an additive manufactured integrated sole and foot form 102 that includes a sole form 104 and foot form 106. The athletic boot 100 further comprises a composite overlay 120 that essentially covers at least 50% of an outer surface 105 of the sole form 104 and at least 50% of an outer surface of the foot form 106. Certain embodiments envision the overlay 120 covering the integrated sole and foot form 102 up to an overlay border 118 that runs along the top of the integrated sole and foot form 102. If the athletic boot 100 is an ice skate boot, the overlay 120 leaves open the mounting holes 130 in the overlay sole portion 124 of the ice skate. Some embodiments envision at least one type of compressible insulation layer fitted against essentially all of an inner surface 109 of the sole and the foot form 102, the athletic boot 100 is configured to be worn on a human foot. The compressible insulation is intended to add comfort from an otherwise stiff additive manufactured integrated sole and foot form 102.

The athletic boot embodiment 100 can further comprise a sole cavity 152 between an inner sole form surface 104A and an outer sole form surface 104B that comprises a void port 146 that extends through either the inner sole form surface 104A or the outer sole form surface 104B. The sole cavity 152 can be essentially filled (that is defined as filed within 80% of the void) with an expandable foam via the void port 146. Optionally, the sole cavity 152 can include support ribs interposed between the inner sole form surface 104A and the outer sole form surface 104B.

Another embodiment of the athletic boot 100 envisions the additive manufactured integrated sole and foot form 102 including a material from a set comprising: nylon, PVC, carbon filled nylon, composite polymer, and poly carbonate, as well as other polymers known to those skilled in the art or being developed at or after the filing date of this document.

The athletic boot embodiment 100 can further envision the additive manufactured integrated sole and foot form 102 including shoelace eyelets 116.

The athletic boot embodiment 100 can further envision the additive manufactured integrated sole and foot form 102 being a 3-dimensionally printed polymer.

The athletic boot embodiment 100 further imagines the composite overlay 120 being at least a 1-layer of carbon mesh essentially encapsulated in resin. Optionally, the composite overlay 120 is constructed via a wet layup process (where a fiber mesh is soaked in a resin and applied to the sole and foot form 102 where the resin also adheres to the sole and foot form 102) or a prepreg process (where a fiber mesh, which is pre-impregnated with a resin, is applied to the sole and foot form 102.

Another embodiment of the athletic boot 100 can further comprise a fabric (such as a vinyl, leather, woven fabric, for example) that covers the composite overlay 120 and a portion of the additive manufactured integrated sole and foot form 102.

The athletic boot embodiment 100 can further envision the composite overlay 120 being a multi-layered laminate (such as carbon fiber, Kevlar fiber, Fiberglass, or other composite layup material), wherein one embodiment contemplates the multi-layered laminate comprising at least two types of polymer.

The athletic boot embodiment 100 can further contemplate the one type of compressible insulation layer including foam.

The athletic boot embodiment 100 can be wherein the additive manufactured integrated sole and foot form 102 includes a toe box 110.

Another embodiment of the athletic boot 100 can further comprise a tongue 160 and a tendon guard 164.

Another embodiment of the athletic boot 100 can further comprise voids interposed between an inner surface 109 and the outer surface 105 of foot sides 108 of the foot form 106. This can help with impact resistance, such as from a hockey puck, for example.

Yet another embodiment contemplates a hard-shell athletic footwear 100 comprising an additive manufactured integrated sole and foot form 102 that includes a sole form 104 and foot form 106 in addition to a composite overlay 120 that essentially covers between 50-90% of an outer surface 105 of the sole form 104 and between 50-90% of an outer surface of the foot form 106. The hard-shell athletic footwear 100 is configured to be worn on a human foot.

An embodiment for a method of manufacturing an athletic boot 100 can comprise 3-D printing an additive manufactured integrated sole and foot form 102 that includes a sole form 104 and foot form 106. Next, apply a composite overlay 120 to the additive manufactured integrated sole and foot form 102 in a manner that essentially covers at least 50% of an outer surface 105 of the sole form 104 and at least 50% of an outer surface of the foot form 106. In certain embodiments, at least one type of compressible insulation layer can be fitted against essentially all of an inner surface 109 of the sole and the foot form 102. The athletic boot 100 is configured to be worn on a human foot.

The above sample embodiments should not be considered limiting to the scope of the invention whatsoever because many more embodiments and variations of embodiments are easily conceived within the teachings, scope and spirit of the instant specification.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms used herein. For example, though embodiments of the present invention describe an ice skate boot, other embodiments envision the construction of different kinds of boots, whether sportswear or otherwise, without departing from the scope and spirit of the present invention. It should also be appreciated that there may be mechanical components that are not discussed in detail in the present disclosure, which must be implemented in accordance known to those skilled in the art. Accordingly, such detail is considered non-additive to the scope and spirit of the present invention as understood by those skilled in the art and should be appreciated is not evidence of lack of disclosure. The specification and drawings are to be regarded as illustrative and exemplary rather than restrictive. For example, the word “preferably,” and the phrase “preferably but not necessarily,” are used synonymously herein to consistently include the meaning of “not necessarily” or optionally. “Comprising,” “including,” and “having,” are intended to be open-ended terms.

It will be clear that the claimed invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the claimed invention disclosed and as defined in the appended claims. Accordingly, it is to be understood that even though numerous characteristics and advantages of various aspects have been set forth in the foregoing description, together with details of the structure and function, this disclosure is illustrative only, and changes may be made in detail, especially in matters of structure and arrangement to the full extent indicated by the broad general meaning of the terms in which the embodiments are expressed.

What is claimed is:

1. Athletic boot comprising:
an additive manufactured integrated sole and foot form that includes a sole form and foot form;
a composite overlay that essentially covers at least 50% of an outer surface of said sole form and at least 50% of an outer surface of said foot form; and
at least one type of compressible insulation layer fitted against essentially all of an inner surface of said sole and said foot form, the athletic boot is configured to be worn on a human foot.

2. The athletic boot of claim 1 further comprising a sole cavity between an inner sole form surface A and an outer sole form surface B.

3. The athletic boot of claim 2, wherein the sole cavity comprises a void port that extends through either said inner sole form surface A or said outer sole form surface B.

4. The athletic boot of claim 3, wherein the sole cavity is essentially filled with an expandable foam via said void port.

5. The athletic boot of claim 2, wherein the sole cavity includes support ribs interposed between said inner sole form surface A and said outer sole form surface B.

6. The athletic boot of claim 1, wherein the additive manufactured integrated sole and foot form includes a material from a set comprising: nylon, PVC, carbon filled nylon, composite polymer, and poly carbonate.

7. The athletic boot of claim 1, wherein the additive manufactured integrated sole and foot form includes shoelace eyelets.

8. The athletic boot of claim 1, wherein the additive manufactured integrated sole and foot form is a 3-dimensionally printed polymer.

9. The athletic boot of claim 1, wherein the composite overlay is at least a 1-layer of carbon mesh essentially encapsulated in resin.

10. The athletic boot of claim 9, wherein the composite overlay is constructed via a wet layup process.

11. The athletic boot of claim 9, wherein the composite overlay is constructed via a prepreg process.

12. The athletic boot of claim 1 further comprising a fabric that covers said composite overlay and a portion of said additive manufactured integrated sole and foot form.

13. The athletic boot of claim 1, wherein the composite overlay is a multi-layered laminate.

14. The athletic boot of claim 13, wherein the multi-layered laminate comprises at least two types of polymer.

15. The athletic boot of claim 1, wherein the at least one type of compressible insulation layer includes foam.

16. The athletic boot of claim 1, wherein the additive manufactured integrated sole and foot form includes a toe box.

17. The athletic boot of claim 1 further comprising a tongue and a tendon guard.

18. The athletic boot of claim 1 further comprising voids interposed between an inner surface and the outer surface of foot sides of said foot form.

19. A hard-shell athletic boot comprising:
an additive manufactured integrated sole and foot form that includes a sole form and foot form; and
a composite overlay that essentially covers at least 50% of an outer surface of said sole form and at least 50% of an outer surface of said foot form, the hard-shell athletic boot is configured to be worn on a human foot.

20. A method for manufacturing an athletic boot can comprising:
3-D printing an additive manufactured integrated sole and foot form that includes a sole form and foot form;
applying a composite overlay to the additive manufactured integrated sole and foot form in a manner that essentially covers at least 50% of an outer surface of the sole form and at least 50% of an outer surface of the foot form;
fitting at least one type of compressible insulation layer against essentially all of an inner surface of the sole and the foot form, the athletic boot being worn on a person's foot.
